(19) United States
(12) Patent Application Publication
(10) Pub. No.: US 2015/0207864 A1
(43) Pub. Date: Jul. 23, 2015

(54) TECHNOLOGY ADAPTED TO ENABLE DEVICES FOR DELIVERING DATA IN A LOCKDOWN MODE, METHODS FOR OPERATING SUCH DEVICES, AND REPORTING ON ACTIVITY AT TABLE DEVICES THAT PROVIDE REMOTE CONTENT

(71) Applicant: Blocks Global P/L, Burwood, Victoria (AU)

(72) Inventors: Paul Wilson, Sydney (AU); Nick Marfleet, Sydney (AU); Bradley Smith, Sydney (AU)

(73) Assignee: Blocks Global P/L, Burwood, Victoria (AU)

(21) Appl. No.: 14/426,159

(22) PCT Filed: Sep. 5, 2013
(86) PCT No.: PCT/AU2013/001010

§ 371 Date: Mar. 4, 2015

(30) Foreign Application Priority Data
Sep. 5, 2012 (AU) 2012903866
Sep. 5, 2012 (AU) 2012903867
Sep. 5, 2012 (AU) 2012903868

(51) Int. Cl. H04L 29/08; H04L 29/06

(52) U.S. Cl. CPC H04L 67/10; H04L 67/42

(57) ABSTRACT

Described herein is technology adapted to enable devices for delivering data in a lockdown mode, methods for operating such devices, and technology for reporting on activity at tablet devices that provide remote content. For example, one embodiment provides a computer implemented method for operating a client device in server-lockdown mode.

### FIELD OF THE INVENTION

The present invention relates to technology adapted to enable devices for delivering data in a lockdown mode, methods for operating such devices, and reporting on activity at tablet devices that provide remote content reporting on activity at tablet devices that provide remote content. Embodiments of the invention have been particularly developed for situations where content is provided to consumers via a touch-enabled device, for example a tablet device that is provided for public/semi-public use. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

It is known to provide a device, such as a touch-enabled device (often a tablet device), touch-screen terminal, kiosk, or the like, thereby to deliver content to consumers in an accessible venue. For example, such devices are common in retail venues, airports, government buildings, and so on. The public accessibility of the devices leads to various complications, as does the distributed nature of such devices.

A key challenge in such situation stems from a desire to prevent users from leveraging a device for purposes other than those intended (for example in terms of personal and/or malicious use). For example, a site manager may provide a tablet device intended to enable visitors to utilise an application that provides site-specific information. However, a user might device to close that app, and use the device for alternate purposes.

### SUMMARY OF THE INVENTION

It is an object of the present invention to overcome or ameliorate at least one of the disadvantages of the prior art, or to provide a useful alternative.

One embodiment provides a computer implemented method for providing reporting data, the method including:

(i) receiving data indicative of user interactions at a plurality of tablet devices;

(ii) receiving data indicative of observations made at the plurality of tablet devices;

(iii) receiving data indicative of client activity at a plurality of data sources accessed by the plurality of tablet devices;

(iv) operating a reporting module thereby to provide one or more reports that collate one or more aspects of data received at two or more of (i), (ii) and (ii).

One embodiment provides a computer implemented method wherein the data received at (ii) includes data derived from monitoring of video data.

One embodiment provides a computer implemented method wherein the data received at (i) and (ii) is received from the plurality of tablet devices.

One embodiment provides a computer implemented method wherein the data received at (i) and (ii) is received from a server that controls the plurality of tablet devices in respective lockdown states.

One embodiment provides a computer implemented method wherein the data received at (iii) is received from servers associated respectively associated with the data sources.

One embodiment provides a computer implemented method wherein the data received at (ii) is processed thereby to report on user activity proximal a given tablet device.

One embodiment provides a computer implemented method wherein the data received at (ii) is processed thereby to report on timeframes over which individual users interact with a given target device.

One embodiment provides a computer implemented method for operating a client device in server-lockdown mode, the method including:

on start-up, executing an agent software module;

providing a check-in request to a remote server determined by the agent software module, wherein the check-in request is indicative of a device UID and an API token;

receiving a control package including data indicative of a manifest checksum;

comparing the manifest checksum of the control package with a local manifest checksum for a locally stored manifest, wherein the manifest defines functionality to be provided by the client device; and

in the case that the manifest checksum of the control package differs from the local manifest checksum, providing to the remote sever a request for an updated manifest.

One embodiment provides a computer implemented method wherein the agent software module is configured to prevent delivery of additional functionality other than that defined in the manifest.

One embodiment provides a computer implemented method further including:

performing an initial check to determine presence of a device UID and an API token in persistent memory; and

in the case that the initial check determines that a device UID or an API token is not present in persistent memory, triggering a registration process thereby to request a device UID and an API token from the remote server.

One embodiment provides a computer implemented method wherein the control package includes data indicative of an activity mode, which defines a mode of operation that is to be adopted by the client device.

One embodiment provides a computer implemented method wherein the manifest references an online data source, thereby to enable access to and rendering of data from the online data source by the client device.

One embodiment provides a computer implemented method wherein the manifest references a remote data repository, thereby to enable access to and downloading of data from the remote data repository by the client device.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A schematically illustrates a framework according to an embodiment.

FIG. 1B schematically illustrates a framework according to an embodiment.

FIG. 2A illustrates client and server method according to an embodiment.

FIG. 2B illustrates client and server method according to an embodiment.

FIG. 2C illustrates client and server method according to an embodiment.

FIG. 3 illustrates an exemplary client-server framework leveraged in some embodiments.

FIG. 4 illustrates a device according to one embodiment.

### DETAILED DESCRIPTION

Described herein is technology adapted to enable devices for delivering data in a lockdown mode, methods for operating such devices, and technology for reporting on activity at tablet devices that provide remote content.

Some embodiments provide devices for delivering data in a lockdown mode, and methods for operating such devices. One embodiment provides a computer implemented method for operating a client device in server-lockdown mode. The method includes, on start-up, executing an agent software module. This agent software module is configured to be launched automatically on start-up, and lock-down the device (by preventing launching of applications or content without agent permission). The agent provides a check-in request to a remote server determined by the agent software module, this check-in request being indicative of a device UID and an API token. In response (assuming successful authentication by the sever, etc), the agent receives a control package including data indicative of a manifest checksum. That agent then compares the manifest checksum of the control package with a local manifest checksum for a locally stored manifest. The locally-stored manifest defines functionality to be provided by the client device (for example in terms of content that is to be displayed by the client device, and/or software modules to be executed by the client device). In the case that the manifest checksum of the control package differs from the local manifest checksum, the agent is configured to provide, to the remote sever, a request for an updated manifest.

### Exemplary System

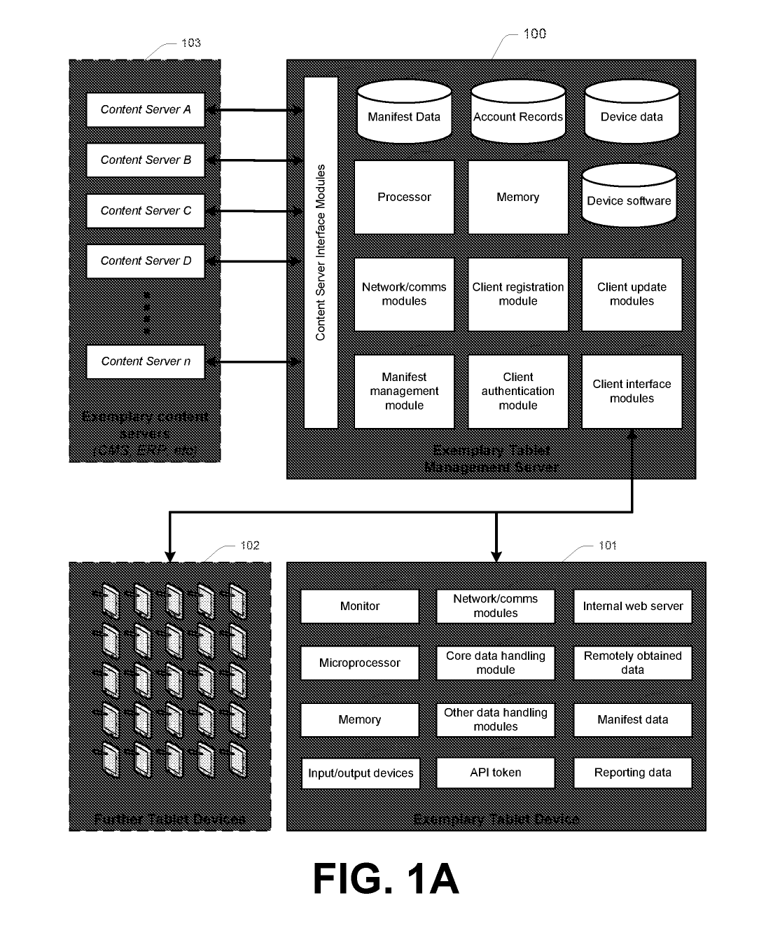

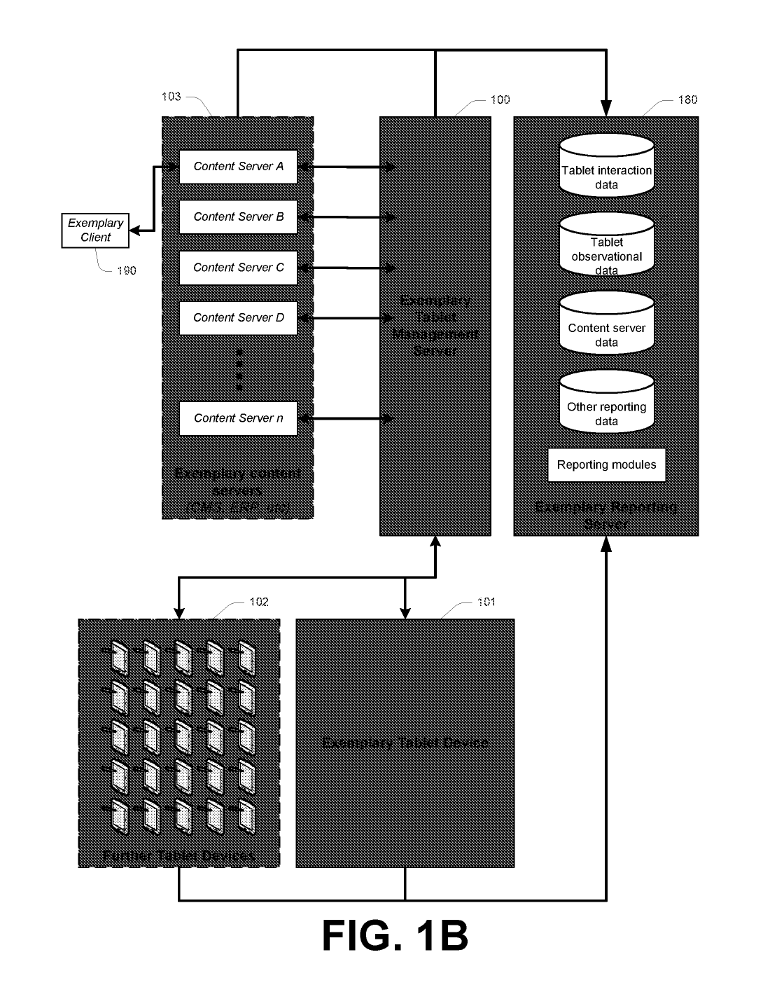

FIG. 1A illustrates a framework according to one embodiment. In overview, the framework centres on a tablet management server 100. Server 100 is configured to be responsible for controlling and communicating with a plurality of remote client devices, which in the present embodiments are tablet devices (i.e. devices each having a touchscreen, microprocessor, memory, and network module). It will be appreciated that other computing devices may be present as client devices in further embodiments. FIG. 1A illustrates an exemplary tablet device 101 in some detail, and a plurality further additional client devices 102. Server 100 also interacts with a plurality of content servers 103, which may include CMS, ERP, and other forms of server. In broad terms, these servers provide instructions to server 100 as to content that is to be displayed at one or more of tablet devices 101 and 102. In this manner, the servers might in practice be associated with a plurality of different organisations, with each organisation having one or more tablet devices at which they wish content to be available.

At a practical level, tablets 101 and 102 are in some embodiments used to provide information kiosks. That is, they are installed in locations such as public buildings, shops, government buildings, and the like for use by the general public (or a subset of the general public). However, that use is not unlimited; there is a desire to operate the tablets in a “lockdown mode” such that only certain content and/or functionality is able to be accessed.

From a hardware perspective, server 100 includes a microprocessor 110, and a memory device 111 (representing volatile and non-volatile memory). Memory device 111 allows for the execution of computer readable code (software instructions) thereby to provide functionality to server 100. Server 100 is described by reference to various “modules”, which in some cases are representative of software-based functionalities provided by server 100 by way of computer executable code. Server 100 also includes network/communications components 113, thereby to facilitate communication with tablets 101 and 102, and servers 103 (optionally in combination with other remote locations), for example via the Internet. In some cases server 100 is a SAAS-based server. It will be appreciated that in some embodiments functionalities of server 100 may be provided by a plurality of distributed components/servers in combination.

Tablet 101 (which may, for example, operate on an Android, Windows, or iOS operating system) includes a monitor 130, coupled to a microprocessor 131 and memory 132 (again thereby to enable the execution of software instructions). Tablet 101 additionally includes input/output devices 133, which may include a touchscreen, one or more buttons, a microphone, a camera, and/or other components that facilitate interaction with a user. Network/communications components 134 enable tablet 101 to communicate with server 101 (and optionally with other devices, such as web serves at which content is hosted).

Tablet 101 includes a core data handling module 135, also referred to as an agent software module. This is a software application that is configured to launch on device start-up without requiring interaction. The agent software module is responsible for interacting with server 100 thereby to ensure that functionality/content provided by tablet 101 is limited to what is instructed by server 100. For example, on an Android operating system enabled device, default ‘home’ screen removed from the home intent list. The device has root access, and registers with the ‘home’ intent.

In some embodiments ongoing communication between the agent software module and server 100 are be performed via HTTP API requests initiated by the agent software module. These requests include an API token, which is associated with a “tablet management account” (i.e. an account for a party that wishes to deliver content via tablet devices) and a device UID (a unique identifier for the specific device, such as tablet 101). In some embodiments, the server/device is configured to establish a long-term bi-directional communications channel using the HTML5 web sockets standard. The continued existence of such a pipeline (along with heartbeat health messages) may additionally be used to determine that a device is present or has online status.

In some embodiments, the server device is configured to enable manual control of devices. For example, a system privileged command' application, (which optionally makes use of web-sockets standards) enables a user to manually (but remotely) trigger actions at a device, such as rebooting, taking screenshots and streaming device logs.

In some embodiments, each tablet 101 makes use of mDNS to auto-discover other running agents that are present on the same subnet. This enables rich inter-device interaction. For example, content may be configured thereby to provide tablet-tablet interaction across a subnet.

Following on from auto-discovery, in some embodiments devices are configured inter-device content sharing. In overview, each device is configured to maintain an internal record of assets (images, videos etc) that it has downloaded. Content Sources may optionally include an asset manifest file, listing the assets that are required to effectively display the content. This manifest take a form such as:

| | |
|---|---|
| asset_path, asset_remote_location, | asset_checksum |

| | | |
|---|---|---|
| /images/man.jpg, | http://imag.es/man.jpg, | xyz123 |
| /videos/video.webm, | http://imag.es/video.webm, | ABC123 |

Following from this, each device is preferably configured to interrogate other devices on the local network and download the required assets via P2P transfer technologies (as opposed to each device separately downloading assets). For example, a device is configured to identify a required asset, determine whether that asset is locally obtainable via P2P, and only download the asset from a remote location in the case that a local version is not available. Such an approach is useful in terms of limiting the bandwidth required per location where there are multiple devices, and improving overall speed and efficiency of content syncing.

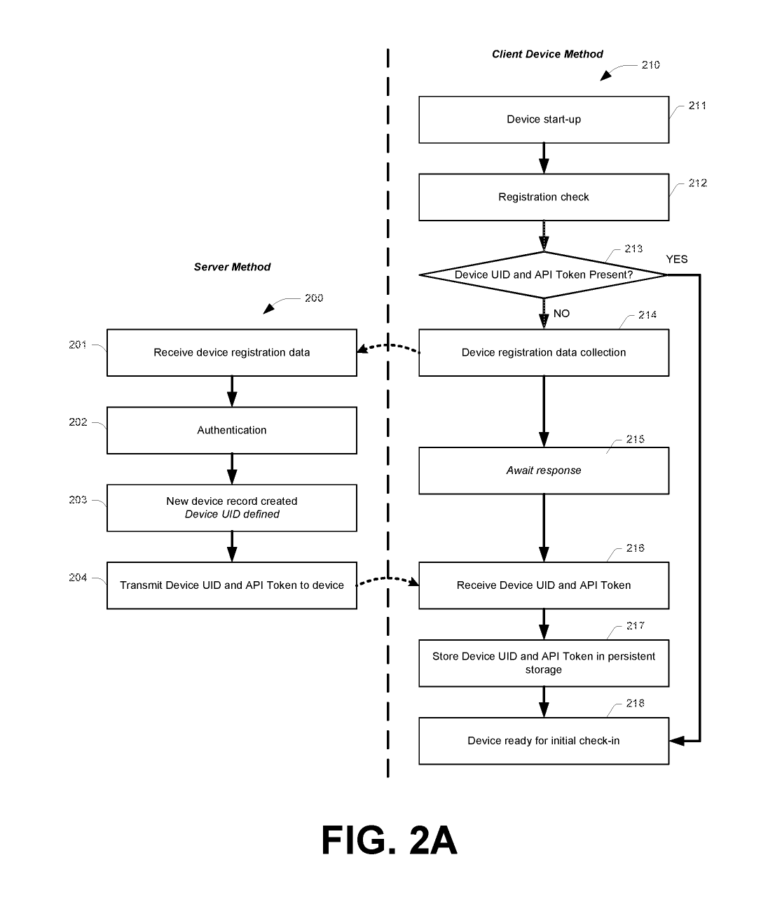

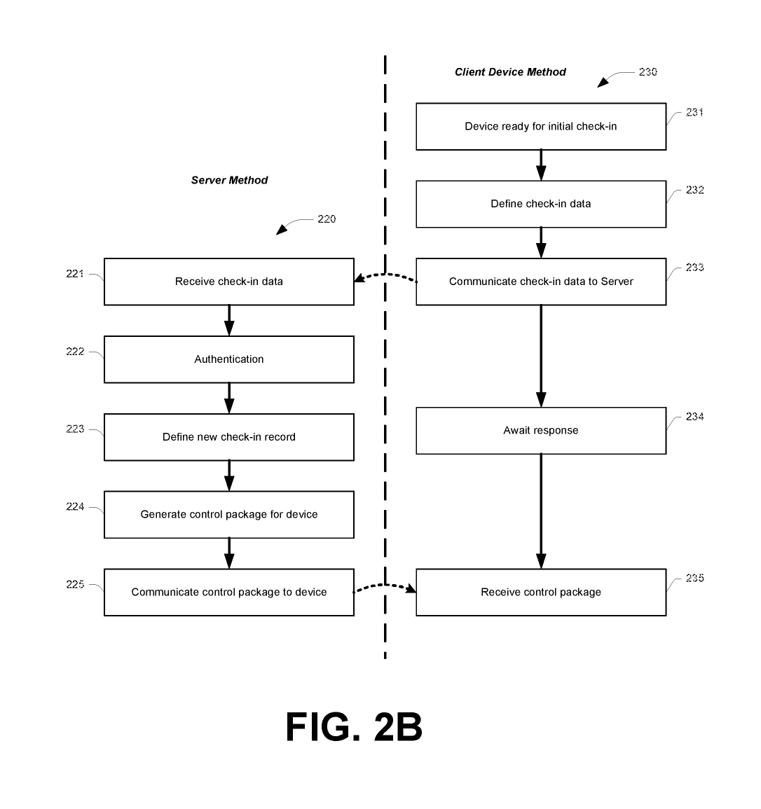

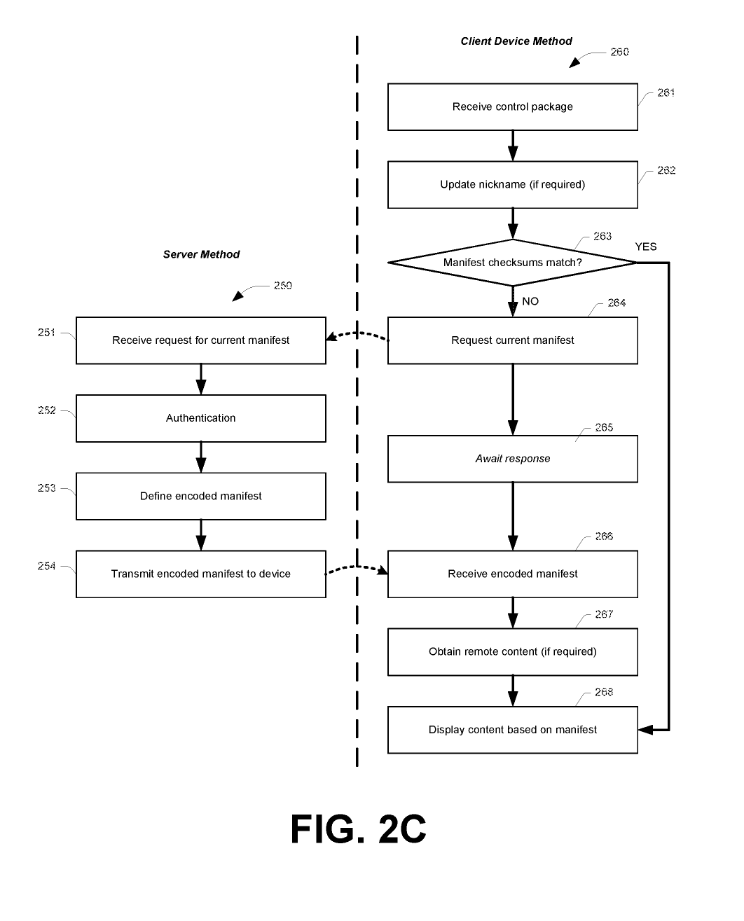

Various functionalities of server 100 and 101 will now be described by reference to methods illustrated in FIG. 2A, FIG. 2B and FIG. 2C. In some cases, these methods are described by reference to modules of servers 100 and 101. However, it will be appreciated that the performance of these method is not necessarily limited in all cases to performed by the hardware of FIG. 1A.

### Device Registration

FIG. 2A illustrates an initial registration check process, defined by a server method 200 and a client device method 210. When agent is started (at start-up, shown at functional block 211), it initially checks (functional block 212) to see whether it has been registered with an account with server 100, referred to herein as a “tablet management account”. This is determined by the presence of a device UID (unique identifier) for the device, and an API token for connecting to the correct tablet management account. A given tablet management account may be associated with a plurality of devices (using the device UIDs). Decision 213 determines whether a device UID and API token are present in device persistent memory. If yes, the method progresses to functional block 218, and the device is ready for an initial check-in. Otherwise, the method progresses to functional block 214.

Functional block 214 represents a process including device registration data collection. For example, the tablet displays a screen configured to receive a username (or email address) and password combination, and a device “nickname” (thereby to allow identification of a specific device), optionally in conjunction with other data. This data is communicated to server 100, and received at functional bock 201. That is, on submission of information by the user, a device registration API call is made to server 100 over HTTP protocol, passing through the provided data.

Server 100 includes client interface modules 118, which configure server 100 to receive data from, and transmit data to, tablet 101 and tablets 102. Upon receiving registration data, module 118 calls a client authentication module 117, which performs an authentication process (block 202), thereby to check whether the username/password combination is correct for a tablet management account for which there is a record in an account record repository 121. On successful authentication, a record of the new device is created (block 203). This includes the random generation of device UID for the tablet in question.

Server 100 responds to a successful registration request, passing back both the newly generated device UID and the API token for the relevant account to tablet 101 (block 204). Preferably this is provided by way of a JSON object.

Tablet 216 receives the device UID and API token at 216, and stores those in persistent memory at 217. The method then progresses to functional block 218, and the device is ready for an initial check-in.

### Initial Check-In

FIG. 2B illustrates an initial check-in process, defined by a server method 220 and a client device method 230. The client device method commences at 231, at which tablet 101 is in a state ready for initial check in, which assumes a valid network connection is present.

Tablet 101 gathers core information about itself, thereby to define check-in data (block 232). In some embodiments, this check-in data includes some or all of the following (optionally in conjunction with additional data):
Current latitude.
Current longitude.
Current orientation.
Currently playing content.
Date/time of the last content poll event.
Build number/identifier.
Network type.
IP address.
SSID of WIFI network the device is connected to (empty value if not connected to a WIFI LAN).
WIFI network signal strength (empty value if not connected to a WIFI LAN).
WIFI speed (empty value if not connected to a WIFI LAN).
Battery level.
Whether the device is running on AC/mains power or battery.
Memory usage.
Memory capacity.
Details of software application modules installed present.
Internal storage remaining/unused.
External storage remaining.
This information is sent to server 100 via an HTTP API call (233).
Server 222 receives the check-in request at block 221, and performs authentication at block 222. The server then creates a new check-in record at 223. Server 100 then generates a control package (block 224) for device 100, based on the check-in request and other data available (for example data influenced by input from the content server 103 associated with the relevant tablet management account). In some embodiments, the control package includes data indicative of
Device nickname (the known nickname of the relevant tablet).
Manifest checksum (a checksum, such as an MD5 checksum, of a manifest associated with the device UID). Server 100 maintains manifest data for all devices in a manifest repository 120.
Activity mode (a currently set activity mode for the tablet).
A check-in interval (an interval, preferably defined in seconds, at which the agent is to perform check-in with the server).

The control package is transmitted to tablet 101 at block 225. The control package is preferably communicated as a JSON object.

### Control Package Processing

FIG. 2C illustrates a process following receipt of a control package, defined by a server method 250 and a client device method 260. The client device method commences at 261, upon receipt of a control package.

At block 262, tablet 101 updates its nickname (if required), which occurs if the nickname in the control package differs from that which is stored in local persistent memory.

At block 262 tablet 101 compares the manifest checksum of the control package with a local manifest checksum for a locally stored manifest. In the case that the checksums match, that indicates that tablet 101 is implementing the current manifest, and the method progresses to 268, at which the tablet displays content (and otherwise provided functionality) based on the current manifest. If the checksums do not match, tablet 100 requests a current manifest from server 100 (block 263) via an API request.

On notification that a manifest update is required (block 251), server 100 authenticates the API request (202), and determines the appropriate manifest. An encoded manifest is defined at 253, will server 100 communicates to tablet 101, at block 254, the manifest name and the encoded manifest. Preferably the manifest is JSON encoded, and the encoded manifest and manifest name wrapped in a JSON object.

Tablet 101 receives and extracts the encoded manifest at 266. The manifest may define different content sources and content types. By way of example, when a web URL is given as the source, and the type is given as ‘online’, the agent is configured to load and display the given website in a full screen web view on the tablet. If the address of a git version control repository is given as the source, and the type is marked as ‘git’, then the device will retrieve the content from the given repository and store it locally (block 257). Once the content has been fully downloaded, the device will display the content in a full screen web view via an internal, embedded web server.

In some cases, display of any new content source will not be triggered until the inactivity timer has expired. As noted above, the control package specifies an interactivity timeout, preferably expressed as an integer representing a period of seconds. After every i seconds of inactivity (i.e. no touch event has occurred on the device), the agent is configured to reload the currently playing web content. Each time activity is detected on the device (e.g. the screen is touched, or a peripheral sensor is triggered), the inactivity timeout resets back to i seconds and begin counting down again. In some embodiments, use of etags on web content optimises such content reloads.

Manifests are, in some embodiments, simply JSON objects with a specific format. Every manifest includes a ‘home’ object which contains information about the content, what type of content it is (online or GIT—other content types to come, e.g. torrent) and the source/address from which to recover the content. A single manifest may be created and assigned to multiple screens in the same account.

In some embodiments, a sample Manifest may be as follows:

{“home”:{“source”:“http://git.sample.com/break/samplecontent.git”,“type”:“git”,“start”:“index.html”,“username”:
“client”,“password”:“samplepassword”,“timeout”:300,“orientation”:“portrait”}}

This manifest defines a source location “http://git.sample.com/break/samplecontent.git”, of type “git”, which is to start with “index.html”. The username and password to access the content are also defined, along with a timeout and orientation.

### Software Module Management

In some embodiments, the agent is responsible for managing the download and management of one or more further software applications that execute on tablet 101. For example, in some embodiments server 100 associates each tablet with a set of software applications that are required to enable delivery of content (and provision of other functionality) defined by a current manifest. Examples of software applications include:
A web browser application.
Eye-tracking and/or other proximity/use monitoring applications.
Analytic data recorders.
Media players.
Games.
NFC/Bluetooth Sensors

In some embodiments details of required applications are included in manifest data, and updating/downloading of new applications is integrated with manifest updating. In other embodiments there is a “content manifest” that defines content to be provided, and a “software manifest” that defines software applications that are to be installed. In the case of the latter, downloading/updating of software applications occurs in a similar manner to updating content, but as a separate process. In both cases, the application updates occur ‘silently’ in the background without user interaction.

It will be appreciated that such approaches for software management have various advantages. For example, a given tablet is able to be shipped to a customer with only the agent software module, and appropriate applications for that customer then downloaded following an initial check in. Furthermore, such approaches allow additional functionality to be provided to tablets over time (e.g. by upgrading existing apps or downloading additional apps) as a server-controlled process.

In some embodiments services are configured to expose an HTTP API thereby to enable certain HTTP based interactions with the device. Examples include:
The ability to trigger Javascript calls in the currently playing content.
The ability to temporarily switch to a different content source.

Such an API is optionally expanded to support any required interactions with the display content and attached peripherals.

### Online/Offline Modes

If an operating device has a valid internet connection (i.e. in an online mode), requests are passed straight through to the requested URL. However, in the event that the device is currently without a valid internet connection, it operates in an offline mode. For the purpose of this offline mode, the device is configured with an agent (for example being defined by a local address) to act as a proxy for live web requests. This agent is configured to hold the requests in a persistent queue, and dispatch them to their intended remote URL destinations upon recommencement of the online mode.

Examples of services that will use this agent include:
Event and error notifications that are passed to the tablet management server.
Statistics that are to be passed to a Statistics/reporting system.
Web form submissions from forms that are present on the current content.
Any other request that must be completed.

Such a store-and-forward (caching) approach is useful in terms of maintaining functionality even where a reliable ongoing internet connection is not available.

### Content Scheduling

In some embodiments, the manifest is defined in a manner to configure content scheduling. For example, inside a manifest, there may be included additional JSON objects representing schedules. Examples include:
An Activity schedule (e.g. whether it should be providing content, or in sleep mode).
A Content schedule (e.g. what content should it be providing at a particular time).

These schedules specify when the content or activity type should be switched to a different content or source. The schedule follows a cascading pattern such that on, for example, 24-12-2012, the scheduling engine will look for schedules labelled: ‘24-12-2012’. If this doesn't exist it will look for one matching the day of the week. If this doesn't exist, it will look for one called ‘daily’. If no appropriate schedule can be found, it will play the default specified content/activity.

In this way, simple to manage, but highly flexible schedules can be created.

An example schedule object is provided below:

{

“activity_schedule”:{

“daily”:{

“playback”:[“0800”],
“blackout”:[“1800”]

},
“fri”:{

“playback”:[“0800”],
“blackout”:[“2100”]

},
“sat”:{

“playback”:[“1000, 1500”],
“blackout”:[“1300, 1700”]

},
“sun”:{
},
“2012-07-25”:{

“playback”:[“2200”],
“blackout”:[“2400”]

}

}

}

It will be appreciated that the underlying concepts are in no way limited by this exemplary code; those skilled in the field will readily recognise other approaches for coding similar functionalities.

### Reporting

As shown in FIG. 1B, in some embodiments a reporting server 180 operates in conjunction with the tablet devices 101 and 102 thereby to provide reporting data for the tablets. Although FIG. 1B shows direct communication between the tablets and the reporting server 180, in some embodiments the all communication between the tablets and reporting server 180 is routed via management server 100. In further embodiments management server 100 and reporting server 180 are wholly or partially integrated in a common server device.

Server 180 is configured to collate the following three aspects of information, thereby to enable the processing of such data (thereby to generate reports, etc):
Tablet interaction data 181. This is preferably recorded using software modules that monitor user interface hardware at the tablet, such as touch screen monitoring modules and the like.
Tablet observation data 182. This is preferably recorded using software modules that monitor an environment surrounding a tablet, such as video analysis software that monitors movement/objects in a field of view of a camera component integrated with or associated with a tablet. For example, this may be used to report on activities of people who view the tablet (and displayed content) but do not necessarily physically interact with the tablet.
Content server interaction data 183. This is collected from the sources themselves (as shown in FIG. 2A) or other analytics/monitoring components external of tablet devices. This enables comparison/correspondence analysis between the data monitored from the tablet, and data accessed at the source (or presented by the source). This is optionally achieved by date stamping of data, and/or similar approaches thereby to allow identification of concordance.

Other forms of reporting data 184 may also be collected. Reporting modules 185 are configured for providing reports (for example tables, graphs, and the like) thereby to allow for user observation and/or analysis of reporting data 181 to 184. These reports may be client specific, tablet specific, source specific, time specific, and so on.

### Software Architecture and Open Model

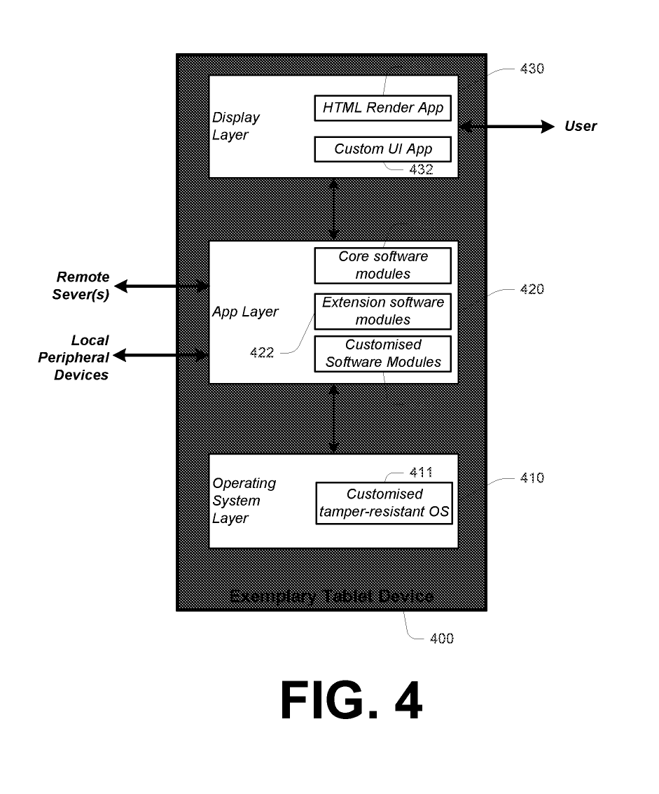

FIG. 4 provides an alternate view of an exemplary tablet device 4, which may be used in embodiments considered above. In overview, FIG. 4 is intended to diagrammatically illustrate three distinct levels of software that operate on device 400. The structuring of these layers both facilitates implementation of methodologies considered above, and additionally facilitates an open model that assists users in customising operation of devices for which they are responsible, whilst leveraging a secure and tamper-resistant framework.

Box 410 represents an operating system layer. The illustrated embodiment makes use of a customised tamper-proof operating system based upon the Android model. The expression “customised tamper-resistant” is used to describe an operating system in which common user interaction functionalities have been omitted and/or suppressed. Such omitted/suppressed functionalities may include the likes of one or more of the following:
Task bars.
Pop-ups and notifications
Default Android (or other) home screen.
Application switching functionalities.

Various other OS default functionalities may also be removed, thereby to strip down a standard OS to a customised form specific to running apps relevant to interactive signage as herein described.

Box 420 represents an application (app) layer 410, defined by a set of software applications that run via the operating system. These applications are non-user-facing. That is, they are apps with which a user does not interact via a user interface. Rather, these applications run in the background thereby to govern functionality of device 400. The applications fall into three main categories:
Core software modules, which are present on all devices (or substantially devices) in an environment (for example devices 101 and 102 of FIG. 1A). These, for example, relate to networking, registration, and the like, for instance (but not limited to) enabling performance of methods 210, 230 and 260. Examples include an agent app, health/diagnostics app, power management app, network manager app, and event manager app.
Extension software modules, which are standard apps available for download thereby to provide additional functionalities. For example, these include apps for managing interactions with peripheral devices, remote servers, and the like.
Customised software modules 420. These are apps generated and/or customised by third parties to provide special functionalities (for example functionalities specifically warranted for a given practical implementation). Again, these may govern interaction with peripheral devices and the like, but the key point is that a framework is provided thereby to enable user-driven customisation so as to enable an open framework for content delivery design and management.

Box 430 represents a display layer, which in essence defines user-facing components. This may utilise an HTML rendering application (for example a web browser app, or customised web browser app) 431, or a custom user interface app 432. It will be appreciated that each of these perform a similar role in the context of providing an on-screen rendering of HTML (and optionally other objects) for the purposes of user viewing and/or interactivity. The main difference is that a custom user interface app is typically able to provide richer and/or more advanced UI components, and hence it is primarily a matter of design choice as to which is used for a given implementation.

Layer 430 communicates with apps in layer 420 via one or more APIs. The presence and availability of such APIs is key in enabling the generation of custom apps; such APIs standardise the manner by which software in layer 430 interacts with apps in the app layer, thereby providing an open framework for enabling functional customisation through apps. By way of example, this may be used to allow integration with third party peripherals thereby to achieve any one or more of the following:
Using proximity (or other) sensors to trigger activity at device 400. For instance, in one example a signal from a sensor is received by an app, and causes an instruction to display particular content via HTML render app 431. In another example, an app receives sensors from signals that indicate when a physical item has been touched/lifted by a person, and instructs app 431 to display content regarding that physical item.
Driving peripheral devices (such as lights, etc) based on activity at device 400. For example, in one embodiment an app is configured to receive a signal indicative of a user accessing information regarding a product in render app 431 and, in response, activate a light that is positioned to illuminate a physical version of that product.
Interacting with NFC tags and the like.

It will be appreciated that the use of APIs to enable interaction between the display layer and app layer enables virtually unlimited scope for customisation and creativity in terms of device functionality, whilst still leveraging remaining within the overall device lockdown and auto-registration framework described further above. The net result is to provide a controlled environment in terms of device registration and general data handling, but which remains open to customisation.

### Exemplary Client-Server Framework

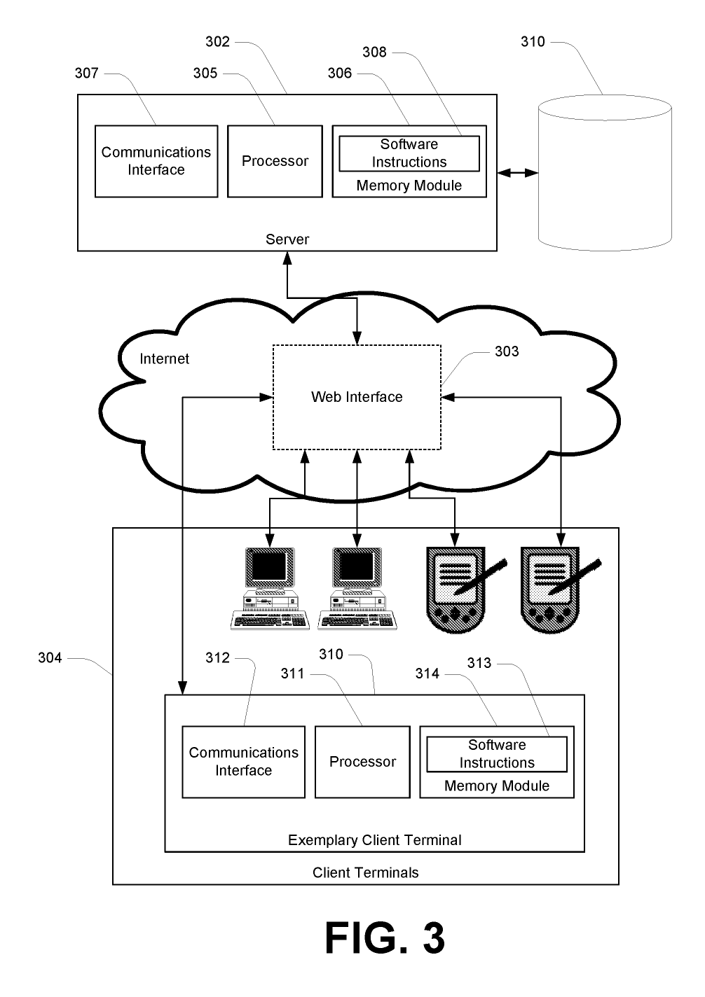

In some embodiments, methods and functionalities considered herein are implemented leveraging a generic client-server framework, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure herein provides useful technology for the delivery of content to a plurality of distributed devices, and capability for reporting in relation to the utilisation of those devices. For example, using technologies and methodologies described herein, a device “ecosystem” is able to be implemented whereby a large number of tablet (or other) devices are able to be deployed and straightforwardly configured to provide content delivery functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for operating a client device, the method including:
configuring the device to execute software across multiple layers, including:
(i) an operating system layer;
(ii) an application layer, defined by a plurality of non-user-facing software applications, including at least one application configured to communicate with a remote server thereby to enable operation of the client device in a server-lockdown mode; and
(iii) a display layer, including at least one client-facing software application that is configured to render HTML code, wherein the at least one software application is configured to interact with the plurality of non-user-facing software applications of the application layer via one or more APIs.

2. A method according to claim 1 wherein the application layer is configured to enable downloading from a server to the device of one or more customised software applications for execution in the application layer, wherein the customised software applications interact with the display layer via one or more of the APIs.

3. A method according to claim 1 wherein the plurality of non-user-facing software applications include at least one software application configured to provide in interface between a peripheral device and the display layer, thereby to enable at least one of:
(i) a signal from the peripheral device resulting in an action at the display layer; and
(ii) an action at the display layer resulting in a signal being provided to the peripheral device.

4. A method according to claim 1 wherein the application layer includes an agent software module, and wherein the method includes: on start-up, executing the agent software module;
providing a check-in request to a remote server determined by the agent software module, wherein the check-in request is indicative of a device UID and an API token;
receiving a control package including data indicative of a manifest checksum;
comparing the manifest checksum of the control package with a local manifest checksum for a locally stored manifest, wherein the manifest defines functionality to be provided by the client device; and
in the case that the manifest checksum of the control package differs from the local manifest checksum, providing to the remote sever a request for an updated manifest.

5. A method according to claim 4 wherein the agent software module is configured to prevent delivery of additional functionality other than that defined in the manifest.

6. A method according to claim 4, further including:
performing an initial check to determine presence of a device UID and an API token in persistent memory; and
in the case that the initial check determines that a device UID or an API token is not present in persistent memory, triggering a registration process thereby to request a device UID and an API token from the remote server.

7. A method according to claim 4 wherein the control package includes data indicative of an activity mode, which defines a mode of operation that is to be adopted by the client device.

8. A method according to claim 4 wherein the manifest references an online data source, thereby to enable access to and rendering of data from the online data source by the client device.

9. A method according to claim 4 wherein the manifest references a remote data repository, thereby to enable access to and downloading of data from the remote data repository by the client device.

10. A method according to claim 4 wherein the manifest includes data indicative of an inactivity timeout, defining operation rules for the client device following a specified inactivity period.

11. A computer implemented method for operating a client device in server-lockdown mode, the method including:
on start-up, executing an agent software module;
providing a check-in request to a remote server determined by the agent software module, wherein the check-in request is indicative of a device UID and an API token;
receiving a control package including data indicative of a manifest checksum;
comparing the manifest checksum of the control package with a local manifest checksum for a locally stored manifest, wherein the manifest defines functionality to be provided by the client device; and
in the case that the manifest checksum of the control package differs from the local manifest checksum, providing to the remote sever a request for an updated manifest.

12. A method according to claim 11 wherein the agent software module is configured to prevent delivery of additional functionality other than that defined in the manifest.

13. A method according to claim 11, further including:
performing an initial check to determine presence of a device UID and an API token in persistent memory; and
in the case that the initial check determines that a device UID or an API token is not present in persistent memory, triggering a registration process thereby to request a device UID and an API token from the remote server.

14. A computer implemented method for providing reporting data, the method including:
(i) receiving data indicative of user interactions at a plurality of tablet devices;
(ii) receiving data indicative of observations made at the plurality of tablet devices;
(iii) receiving data indicative of client activity at a plurality of data sources accessed by the plurality of tablet devices;
(iv) operating a reporting module thereby to provide one or more reports that collate one or more aspects of data received at two or more of (i), (ii) and (iii).

15. A method according to claim 14 wherein the data received at (ii) includes data derived from monitoring of video data.

16. A method according to claim 14 wherein the data received at (i) and (ii) is received from the plurality of tablet devices.

17. A method according to claim 14 wherein the data received at (i) and (ii) is received from a server that controls the plurality of tablet devices in respective lockdown states.

18. A method according to claim 14 wherein the data received at (iii) is received from servers associated respectively associated with the data sources.

19. A method according to claim 14 wherein the data received at (ii) is processed thereby to report on user activity proximal a given tablet device.

20. A method according to claim 14 wherein the data received at (ii) is processed thereby to report on timeframes over which individual users interact with a given target device.

21. (canceled)

22. (canceled)
